(19) United States
(12) Patent Application Publication
(10) Pub. No.: US 2003/0201976 A1
(43) Pub. Date: Oct. 30, 2003

(54) Dust-proof design for electronic mouse

(75) Inventor: Bin-Hui Huang, Pan Chiao City (TW)

Correspondence Address: BRUCE H. TROXELL, SUITE 1404, 5205 LEESBURG PIKE, FALLS CHURCH, VA, 22041, US

(73) Assignee: Primax Electronics Ltd.

(21) Appl. No.: 10/128,309

(22) Filed: Apr. 24, 2002

(51) Int. Cl. G09G 5/08

(52) U.S. Cl. 345/163

(57) ABSTRACT

An electronic mouse is a three-dimensional structure composed by a bottom face, a holding face, a supporting face and a handling face. The holding face is used for fingers to grip; the handling face is used for fingers to press; the supporting face is used for a palm to prop and thereby to drive the bottom face of the mouse to move on a carried surface. A cavity is formed at an appropriate location of the bottom face, and a ball cover having a circular hole is combined to the cavity, and a ball is received in the cavity and protrudes through the circular hole to be in contact with the carried surface. The feature lies in that foot pads are mounted around the bottom face of the mouse to slide on the carried surface and thus to form a sliding face, and that protruding stripes are mounted on the bottom face between the foot pads and the circular hole, and that there is a spacing between the bottom of said respective protruding stripe and said sliding face, whereby the protruding stripes can block dirt and debris on the carried surface during the mouse is sliding so as to prevent the dirt and debris from entering into the cavity through the circular hole and thus to avoid unfavorable influences of the operating performance of the mouse.

### FIELD OF THE INVENTION

The present invention relates to a structure design for a electronic mouse, more particularly, to a computer mouse having a dust-proof function.

### BACKGROUND OF THE INVENTION

With the rapid and flourishing developments in the digital technology, information processing apparatuses such as computers have been widely applied in various fields. When employing a computer to process digital data or files, as long as an operator inputs command signals into the computer through peripheral equipment, the computer will execute appropriate operations based on the received command signals. A computer mouse is still more an indispensable item among numerous computer peripheral devices.

Please refer to FIGS. 1A and 1B, which are schematic diagrams of the structure of a conventional computer mouse 10, a three-dimensional structure composed by a bottom face 11, a holding face 12, a supporting face 13 and a handling face 14. The bottom face 11 is disposed at the bottom of the mouse 10 and is held on a carried surface such as a tabletop. The holding face 12 is disposed at the two sides of the mouse 10. The handling face 14 and the supporting face 13 are respectively disposed at the front portion and the rear portion of the top surface of the mouse 10. When the user holds the mouse 10 by hand, the thumb is placed at the holding face 12 of one side of the mouse 10 and the ring finger and the little finger are placed at the holding face 12 of the other side of the mouse 10, thus gripping the mouse 10 therebetween by the clipping force of the fingers. At this time, the palm of the user is propped on the supporting face 13 at the rear portion of the top surface of the mouse 10, and the index finger as well as the middle finger is used to press keys on the handling face 14 such that the mouse 10 can bring corresponding press commands, wherein the handling face 14 consists of two or three keys.

In order to successfully transform the moving direction and momentum of the mouse 10 into sensing signals and to convey the sensing signals to the interior of the computer for execution and operation, the bottom face 11 of the mouse 10 has a cavity 15 in which a plurality of direction rollers 16 are mounted and a ball 17 can be received. After the ball 17 is put into the cavity 15, a ball cover 19 having a circular hole 18 is combined to the cavity 15, wherein the cavity 15 and the circular hole 18 are most preferably located at an appropriate middle of the bottom face 11. Moreover, foot pads 20 of different configurations are mounted around the bottom face 11. As shown in FIG. 1B, the foot pads 20 are disposed at the upper and lower sides of the bottom face 11, and are formed as a bar.

Referring now to FIG. 2, when the mouse 10 is placed on a carried surface 21, the bottom face 11 is glidingly in contact with the carried surface 21 by the foot pads 20, that is, a sliding face is formed where the foot pads 20 contact the carried surface 21, and the ball 17 in the cavity 15 partially protrudes through the circular hole 18 and comes into contact with the carried surface 21, and simultaneously, the surface of the ball 17 also makes contact with the direction rollers (not shown) in the cavity 15. If the user pushes the mouse 10 to move on the carried surface 21, the ball 17 underneath drives the direction rollers to rotate due to rolling friction and then, the circuit devices inside of the mouse 10 will transform the moving direction and momentum of the direction rollers into sensing signals which are transported to the computer for processing.

However, since the conventional computer mouse 10 is not dust-proof, the ball 17 underneath the mouse 10 is liable to be stained with dirt or debris, e.g. lint etc. on the carried surface 21 after being used over a long period of time. If the ball 17 carries such dirt and debris into the cavity 15, the rotation of the direction rollers will be affected. The operating performance of the mouse 10 becomes impaired, and the mouse 10 would even be discarded.

To solve the above-mentioned problem, the manufacturers of computer mice and the related researchers make vigorous efforts to improve computer mice such that computer mice can have the dust-proof function to prevent the inner devices from being stained with outer dirt and debris and thereby to increase their performance and lifetime.

### SUMMARY OF THE INVENTION

The primary objective of the present invention is to provide a dust-proof design for an electronic mouse. The electronic mouse can effectively stop dirt and debris from entering into the interior of the mouse so that the operating performance and lifetime of the mouse can be raised.

In one embodiment of this invention, the electronic mouse is a three-dimensional structure composed by a bottom face, a holding face, a supporting face and a handling face. The bottom face is disposed at the bottom of the mouse and held on a carried surface. The holding face is disposed at the two sides of the mouse. The handling face and the supporting face are respectively disposed at the front portion and the rear portion of the top surface of the mouse.

In order to transform the moving direction and momentum of the mouse into sensing signals, the bottom face of the mouse has a cavity in which a plurality of direction rollers are mounted and a ball is received. After the ball is put into the cavity, a ball cover having a circular hole is combined to the cavity, wherein the cavity and the circular hole are located at the middle of the bottom, and foot pads of different forms are mounted around the bottom face.

When the mouse is placed on the carried surface, the bottom face of the mouse is glidingly in contact with the carried surface by the foot pads such that a sliding face is formed between the foot pads and the carried surface, and the ball in the cavity partially protrudes through the circular hole and comes into contact with the carried surface, and simultaneously, the surface of the ball also makes contact with the direction rollers in the cavity. The operation of the mouse of the present invention is identical to that of the prior art, and thus will not be reiterated herein. While a user pushes the mouse by his/her wrist to move on the carried surface, the ball underneath drives the direction rollers to rotate due to rolling friction and then, the interior circuit devices of the mouse will transform the moving direction and momentum of the direction rollers into sensing signals which are transported to the computer for processing.

To prevent the outer dirt and debris from being attached to the cavity of the mouse due to utilization of the mouse over a long period of time such that the operating performance of the mouse would not be affected to become impaired and even to be discarded, the present invention is characterized by mounting curved protruding stripes, which do not touch the sliding face, on the bottom face between the foot pads and the circular hole of the ball cover. The protruding stripes can block the dirt and debris on the carried surface during the mouse is sliding so as to prevent the outer dirt and debris from entering into the cavity through the circular hole and thus to avoid unfavorable influences of the operating performance and lifetime of the mouse.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIGS. 1A and 1B are schematic construction diagrams of a computer mouse in the prior art;

FIG. 2 is a partially cross sectional view of the conventional computer mouse placed on a carried surface;

FIG. 3 is a schematic construction diagram of a dust-proof design for an electronic mouse in accordance with the present invention; and

FIG. 4 is a partially cross sectional view of the electronic mouse placed on a carried surface in accordance with the present invention.

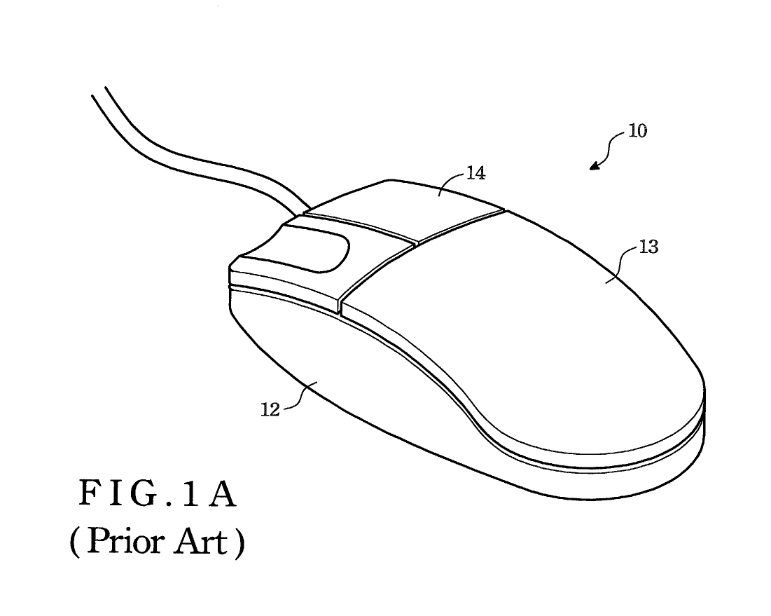

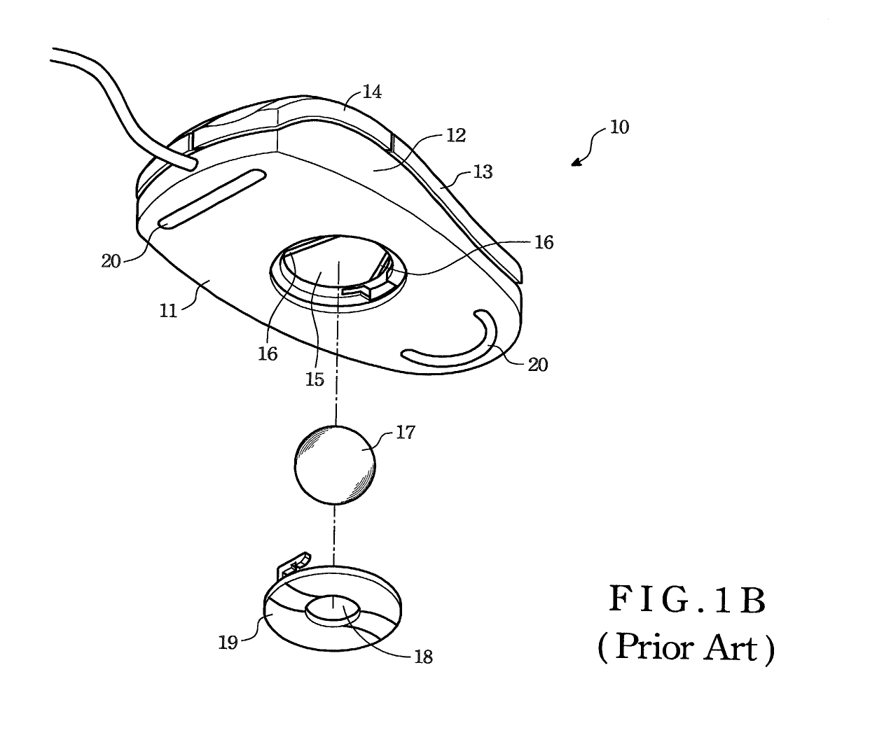

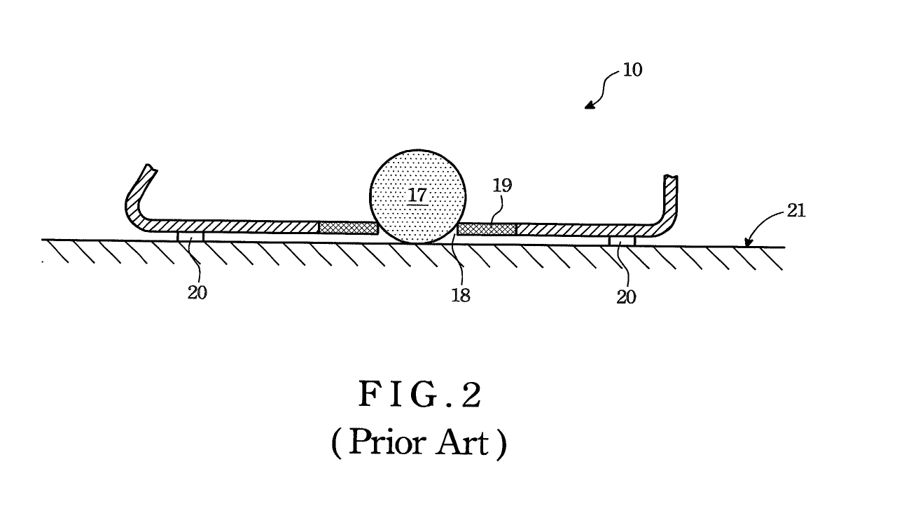

### DETAILED DESCRIPTION OF THE PREFERRED EMBODIMENT

A dust-proof design for an electronic mouse of this invention is disclosed, which design can obstruct the outer dirt and debris so as to avoid their unfavorable influences on the devices inside of the mouse and further to raise the operating performance and lifetime of the mouse. The detailed description of the present invention is given by the following best mode for illustration.

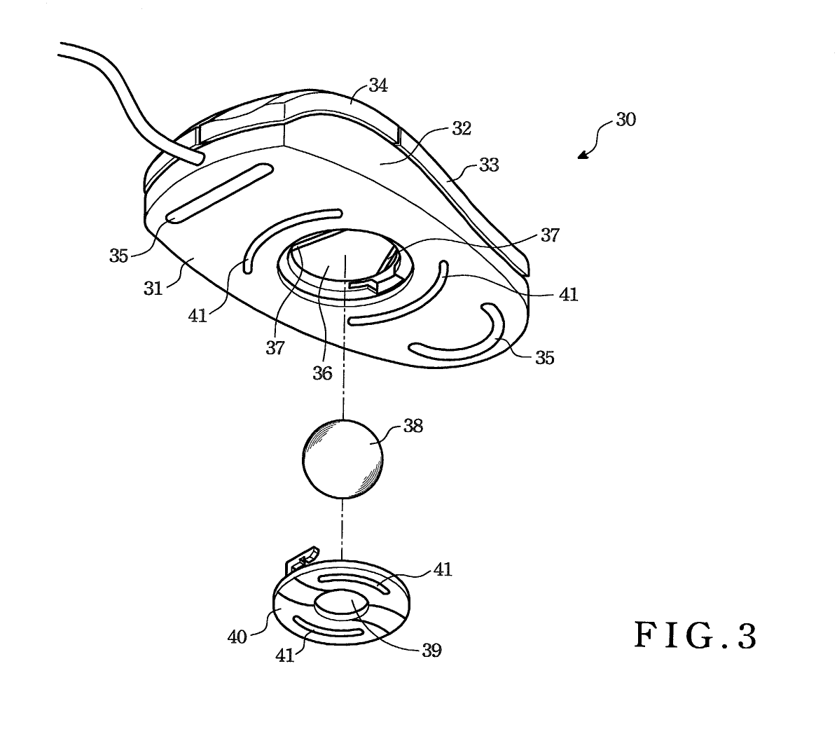

Please refer to FIG. 3, which is a schematic construction diagram of the dust-proof design for an electronic mouse 30 of this invention. The electronic mouse 30 is a three-dimensional structure composed by a bottom face 31, a holding face 32, a supporting face 33 and a handling face 34. The bottom face 31 is disposed at the bottom of the mouse 30, and foot pads 35 are mounted at the upper and lower sides of the bottom face 31 or around the bottom face 31. The mouse 30 is held on a carried surface such as a desk top (not shown) and the bottom face 31 is glidingly in contact with the carried surface by the foot pads 35. The holding face 32 is disposed at the two sides of the mouse 30. The handling face 34 and the supporting face 33 are respectively disposed at the front portion and the rear portion of the top surface of the mouse 30.

A user holds the mouse 30 with the thumb placed at the holding face 32 of one side of the mouse 30 and with the ring finger and the little finger placed at the holding face 32 of the other side of the mouse 30. The palm of the user is propped on the supporting face 33 at the rear portion of the top surface of the mouse 30, and the index finger as well as the middle finger is used to press keys on the handling face 34 such that the mouse 30 can bring corresponding press commands, wherein the handling face 34 consists of two or three keys. The operation of the mouse 30 is conventional, and thus will not be reiterated herein.

In order to transform the moving direction and momentum of the mouse 30 into sensing signals, the bottom face 31 of the mouse 30 has a cavity 36 in which a plurality of direction rollers 37 are mounted and a ball 38 is received. After the ball 38 is put into the cavity 36, a ball cover 40 having a circular hole 39 is combined to the cavity 36, wherein the cavity 36 is located at the middle of the bottom face 31.

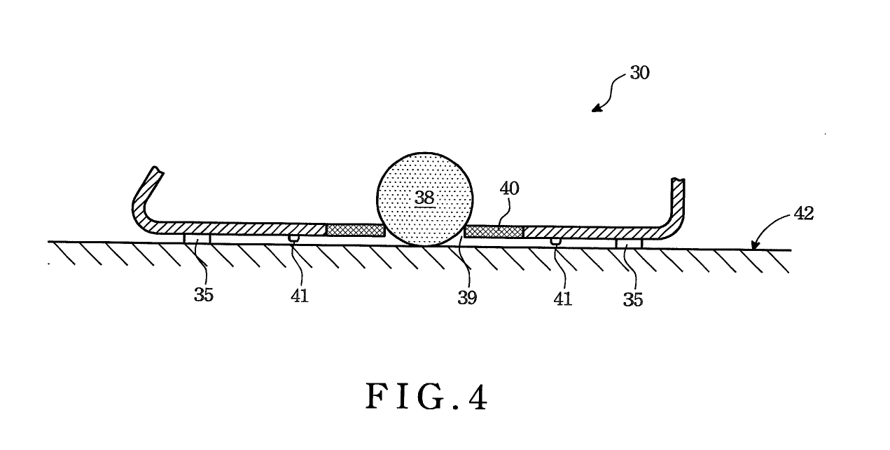

When the mouse 30 is placed on a carried surface 42 (as shown in FIG. 4 which is a partially cross sectional view of the electronic mouse placed on a carried surface in this invention), the bottom face 31 is glidingly in contact with the carried surface 42 by the foot pads 35 such that a sliding face is formed where the foot pads 35 contact the carried surface 42, and the ball 38 in the cavity 36 partially protrudes through the circular hole 39 and comes into contact with the carried surface 42, and simultaneously, the surface of the ball 38 also makes contact with the direction rollers 37 in the cavity 36. While the user pushes the mouse 30 by his/her wrist to move on the carried surface 42, the ball 38 underneath drives the direction rollers 37 to rotate due to rolling friction and then, the circuit devices inside of the mouse 30 will transform the moving direction and momentum of the direction rollers 37 into sensing signals which are transported to the computer for processing.

Referring to both FIG. 3 and FIG. 4, the feature of the present invention resides in that protruding stripes 41 are mounted on the bottom face 31 between the foot pads 35 and the circular hole 39 of the ball cover 40, and that there is a spacing between the bottom of the respective protruding stripe 41 and the sliding face where the foot pads 35 contact the carried surface 42. Most preferably, the shape of the protruding stripes 41 is an arc and the thickness thereof is slightly less than that of the foot pads 35. The main function of the protruding stripes 41 is to separate the dirt and debris on the carried surface 42 from being carried by the ball 38 during its rotating into the cavity 36 and thus to avoid unfavorable influences of the operating performance and lifetime of the mouse 30.

The protruding stripes 41 are mounted on the bottom face 31 or on the ball cover 40, and can be integrally molded with the mouse 30, or can be combined onto the mouse 30 by adhesion.

Comparing with the prior art, indeed the present invention can effectively reduce the dirt and debris entering into the cavity 36, and thus can greatly raise the operating efficiency of the mouse 30 and prolong the lifetime thereof.

As is understood by a person skilled in the art, the foregoing preferred embodiment of the present invention is illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed:

1. A dust-proof design for an electronic mouse, said electronic mouse being a three-dimensional structure composed by a bottom face, a holding face, a supporting face and a handling face; said holding face being used for fingers to grip; said handling face being used for fingers to press and work; said supporting face being used for a palm to prop and thereby to drive said bottom face of said mouse to move on a carried surface; wherein a cavity is formed at an appropriate location of said bottom face, and a ball cover having a circular hole is combined to said cavity, and a ball is received in said cavity and protrudes through said circular hole to be in contact with said carried surface; said design is characterized in that:
foot pads are mounted around said bottom face of said mouse to slide on said carried surface and thus to form a sliding face, and protruding stripes are mounted on said bottom face between said foot pads and said circular hole, and there is a spacing between the bottom of said respective protruding stripe and said sliding face, whereby said protruding stripes can block dirt and debris on said carried surface during said mouse is sliding so as to prevent said dirt and debris from entering into said cavity through said circular hole and thus to avoid unfavorable influences of the operating performance of said mouse.

2. The dust-proof design of claim 1, wherein said protruding stripe is a curved structure around said circular hole.

3. The dust-proof design of claim 1, wherein said protruding stripes are integrally molded with said mouse.

4. The dust-proof design of claim 1, wherein said protruding stripes are combined onto said bottom face of said mouse by adhesion.

5. The dust-proof design of claim 1, wherein a plurality of direction rollers are mounted in said cavity, and are respectively in contact with the surface of said ball, and are simultaneously driven to rotate while said ball rotates so as to produce corresponding sensing signals according to the moving direction and momentum of said mouse.

6. The dust-proof design of claim 1, wherein said protruding stripes are mounted on said ball cover.

7. The dust-proof design of claim 1, wherein said handling face of said mouse comprises a plurality of keys and corresponding command signals are produced when fingers press said keys.

8. The dust-proof design of claim 1, wherein said mouse is connected to an information processing apparatus to which said sensing signals and said command signals produced respectively from sliding and being pressed of said mouse are transported for processing.

9. The dust-proof design of claim 1, said information processing apparatus is a computer.
